(19) United States
(12) Patent Application Publication
(10) Pub. No.: US 2023/0111200 A1
(43) Pub. Date: Apr. 13, 2023

(54) AEROSOL-GENERATING DEVICE FOR INDUCTIVE HEATING OF AN AEROSOL-FORMING SUBSTRATE

(71) Applicant: Philip Morris Products S.A., (US)

(72) Inventors: Oleg MIRONOV, Cudrefin (CH); Jerome Christian COURBAT, Cortaillod (CH); Enrico STURA, Palezieux-Village (CH)

(73) Assignee: Philip Morris Products S.A., Neuchatel (CH)

(21) Appl. No.: 17/768,797

(22) PCT Filed: Oct. 14, 2020
(86) PCT No.: PCT/EP2020/078964

§ 371 Date: Apr. 13, 2022

(30) Foreign Application Priority Data
Oct. 15, 2019 (EP) 19203346.2

(51) Int. Cl. A24F 40/465; H05B 6/10; H05B 6/36; A24F 40/20

(52) U.S. Cl. CPC A24F 40/465; H05B 6/105; H05B 6/36; A24F 40/20

(57) ABSTRACT

An aerosol-generating device is provided for generating an aerosol by inductive heating of an aerosol-forming substrate, the device including: a device housing including a cavity to removably receive the substrate; first and second induction coils arranged and configured to generate an alternating magnetic field within first and second sections of the cavity, respectively; and a control circuit to selectively drive the first and the second coils to selectively generate an alternating magnetic field within the first and the second sections, respectively, the circuit including: a first LC resonator circuit including the first coil and a first capacitor, and a second LC resonator circuit including the second coil and a second capacitor, the first and the second circuits having a first and a second resonance frequency, respectively, and a driving oscillator circuit including a common oscillator coil to selectively generate an alternating magnetic oscillator field. An aerosol-generating system is also provided.

The present invention relates to an aerosol-generating device for generating an aerosol by inductively heating an aerosol-forming substrate. The invention further relates to an aerosol-generating system comprising such a device and an aerosol-generating article, wherein the article comprises the aerosol-forming substrate to be heated.

Aerosol-generating systems based on inductively heating an aerosol-forming substrate that is capable to form an inhalable aerosol are generally known from prior art. Such systems may comprise an aerosol-generating device having a cavity for receiving the substrate to be heated. The substrate may be integral part of an aerosol-generating article that is configured for use with the device. For heating the substrate, the device may comprise an inductive heater that includes an induction source comprising an induction coil for generating an alternating magnetic field within the cavity. The field is used to inductively heat a susceptor which is arranged in thermal proximity or direct physical contact with the substrate such as to heat the substrate. In general, the susceptor may be either integral part of the device or integral part of the article.

To separately heat different segments of the susceptor and/or the substrate, the device may comprise a plurality of induction coils for selectively generating a plurality of magnetic fields. Accordingly, the induction source may be configured so that when one of the coils is actively being driven to generate a varying magnetic field the other coils are inactive. Typically, this is achieved by a control circuit which comprises a transistor switch for each induction coil. However, using a plurality of transistor switches requires a precise control of the switching operation, in particular time-wise, in order to avoid severe damages of the transistors due to an undesired power overload. Moreover, often the inactive coils cannot be sufficiently prevented from carrying a current induced by the active coil such that there is still significant heating where it actually is not desired.

Therefore, it would be desirable to have an aerosol-generating device and system for inductively heating an aerosol-forming substrate with the advantages of prior art solutions but without their limitations. In particular, it would be desirable to have an inductively heating aerosol-generating device and system comprising a control circuit for selectively driving a multitude of induction coils with little complexity and a high reliability.

According to the invention there is provided an aerosol-generating device for generating an aerosol by inductive heating of an aerosol-forming substrate. The device comprises a device housing comprising a cavity configured for removably receiving the aerosol-forming substrate to be heated. The device further comprises at least a first induction coil and a second induction coil. The first induction coil is arranged and configured to generate an alternating magnetic field within a first section of the cavity. The second induction coil is arranged and configured to generate an alternating magnetic field within a second section of the cavity. The device further comprises a control circuit for selectively driving the first induction coil and the second induction coil to selectively generate an alternating magnetic field within the first and the second section, respectively. The control circuit comprises a first LC resonator and a second LC resonator circuit, wherein the first LC resonator circuit includes the first induction coil and a first capacitor, and wherein the second LC resonator circuit includes the second induction coil and a second capacitor. The first LC resonator has a first resonance frequency and the second LC resonator circuit has a second resonance frequency that is different from the first resonance frequency. The control circuit further comprises a driving oscillator circuit comprising an oscillator coil for selectively generating an alternating magnetic oscillator field having a frequency either close to or at the first resonance frequency, or close to or at the second resonance frequency. The oscillator coil is inductively coupled to the first induction coil and to the second induction coil such that an alternating magnetic field is generated within the first section when the frequency of the oscillator field is close to or at the first resonance frequency and thus close to or on resonance with the first LC resonator circuit, and that an alternating magnetic field is generated within the second section when the frequency of the oscillator field is close to or at the second resonance frequency and thus close to or on resonance with the second LC resonator circuit.

According to the invention it has been recognized that a plurality of induction coils—used for selectively generating a plurality of magnetic fields—may be selectively driven by making each coil part of a respective LC resonator circuit which has a distinct resonance frequency, and by inductively coupling each LC resonator circuit to a driving oscillator coil which can be selectively operated at the distinct resonance frequencies. Advantageously, due to the distinct resonance frequencies, the inactive coils are sufficiently prevented from carrying a current induced by the active coil as the inactive coils are off-resonance with respect to the current operating frequency of the oscillator coil. In addition, this control circuitry is less complex, in particular requires no precise control of a plurality of transistor switches.

The frequency difference between the first resonance frequency and the second resonance frequency preferably is chosen at least as large as necessary to inductively decouple the first and second induction coils from each other such that only one of the coils is operable at a time while the respective other coil is inactive and sufficiently prevented from carrying a current induced by the active coil. In general, the frequency difference between the first and second resonance frequency depends on a plurality of factors. As will be described in more detail below, the frequency difference in particular depends on the quality factor of the first LC resonator circuit and the second LC resonator circuit, respectively. The quality factor characterizes the bandwidth of the respective resonator circuit relative to its center resonance frequency. A high quality factor is typically associated with a small bandwidth which in turn allows for a smaller frequency difference between the first resonance frequency and the second resonance frequency.

Preferably, the first resonance frequency is in a range between 1% (percent) and 20% (percent) of the second resonance frequency. For example, when the second resonance frequency is 20 MHz (Mega-Hertz), the first resonance frequency is in range between 200 kHz (kilo-Hertz) and 4 MHz (Mega-Hertz). Of course, it is also possible that the second resonance frequency is in a range between 1% (percent) and 20% (percent) of the first resonance frequency.

In absolute numbers, the first resonance frequency may differ from the second resonance frequency by at least 40 kHz (kilo-Hertz), in particular at least 100 kHz (kilo-Hertz), preferably at least 200 kHz (kilo-Hertz), more preferably at least 500 kHz (kilo-Hertz) or 1 MHz (Mega-Hertz). For example, the first resonance frequency differs from the second resonance frequency by 120 kHz (kilo-Hertz). A frequency difference between the first and second resonance frequencies in this range is particularly suitable to inductively decouple the first and second induction coils sufficiently from each other.

For the same reason, at least one of the first LC resonator circuit and the second LC resonator circuit, preferably both LC resonator circuits, may have a quality factor in a range between 2 and 50, in particular between 2 and 20, for example 10. As used herein, the term “quality factor” denotes a dimensionless parameter that characterizes the bandwidth of the respective resonator circuit relative to its center resonance frequency and describes how underdamped the respective resonator circuit. That is, the quality facto relates the maximum or peak energy stored in the circuit (the reactance) to the energy dissipated (the resistance) during each cycle of oscillation. A higher quality factor indicates a lower rate of energy loss relative to the stored energy of the resonator; the oscillations die out more slowly. Hence, increasing the quality factor of the first LC resonator circuit and the second LC resonator circuit causes the bandwidth of the first LC resonator circuit and the second LC resonator circuit to decrease, which advantageously suppresses the coupling of the respective LC resonator circuit to off-resonant magnetic fields. This in turn prevents the respective inactive coil from carrying a current induced by the respective active coil. Furthermore, increasing the quality factors of the first LC resonator circuit and the second LC resonator circuit minimizes the loss of energy in the LC resonator circuits and thus increases the heating efficiency.

The first resonance frequency and the second resonance frequency are preferably chosen to be in a range between 100 kHz (kilo-Hertz) to 30 MHz (Mega-Hertz), in particular between 5 MHz (Mega-Hertz) and 15 MHz (Mega-Hertz), preferably between 5 MHz (Mega-Hertz) and 10 MHz (Mega-Hertz). The first resonance frequency and the second resonance frequency preferably correspond to the operation frequency of the first induction coil and the second induction coil, respectively. For example, at least one of the first resonance frequency and the second resonance frequency may be in range between 100 kHz (kilo-Hertz) and 300 kHz (kilo-Hertz), in particular between 150 kHz (kilo-Hertz) and 270 kHz (kilo-Hertz).

The respective operation frequency in turn corresponds to the frequency of the alternating magnetic field generated by the first induction coil and the second induction coil within the first section and the second section of the cavity, respectively. Preferably, the respective alternating magnetic fields are high frequency alternating magnetic fields. As referred to herein, the high-frequency magnetic fields may have a frequency in a range between 100 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz). Such values have proven advantageous for induction heating in aerosol-generating devices. Accordingly, the first resonance frequency and the second resonance frequency may be in a range between 100 kHz (kilo-Hertz) to 30 MHz (Mega-Hertz), in particular between 5 MHz (Mega-Hertz) and 15 MHz (Mega-Hertz), preferably between 5 MHz (Mega-Hertz) and 10 MHz (Mega-Hertz). For example, at least one of the first resonance frequency and the second resonance frequency may be in range between 100 kHz (kilo-Hertz) and 300 kHz (kilo-Hertz), in particular between 150 kHz (kilo-Hertz) and 270 kHz (kilo-Hertz).

As referred to herein, the frequency of the oscillator field is close to the first or second resonance frequency, respectively, when a difference between the frequency of the oscillator field and the first or second resonance frequency, respectively, is less than 500 kHz (kilo-Hertz), in particular less than 100 kHz (kilo-Hertz), preferably less than 50 kHz (kilo-Hertz), more preferably less than 20 kHz (kilo-Hertz), even more preferably less than 10 kHz (kilo-Hertz, most preferably less than 5 kHz (kilo-Hertz).

The oscillator coil is preferably arranged coaxially with at least one of, in particular with each one of the first induction coil and the second induction coil. Due to the coaxial arrangement, the magnetic field generated by the oscillator coil largely overlaps with the first induction coil and the second induction coil, respectively. Advantageously, this increases the inductive coupling between the oscillator coil and the first induction coil and the second induction coil, respectively.

Likewise, the oscillator coil may at least partially surround at least one of, in particular each one of the first induction coil and the second induction coil. Advantageously, this also increases the inductive coupling between the oscillator coil and the first induction coil and the second induction coil, respectively.

Preferably, the oscillator coil is arranged coaxially with and at least partially around at least one of, in particular each one of the first induction coil and the second induction coil. That is, the oscillator coil may at least partially surround and may be arranged coaxially with at least one of, in particular each one of the first induction coil and the second induction coil. Advantageously, this increases even more the overlap between the magnetic fields of the different coils and thus the inductive coupling between the oscillator coil and the first and the second induction coil.

A least one of, in particular each one of the oscillator coil, the first induction coil and the second induction coil may be a helical coil. A helical coil configuration proves particularly advantageous for a coaxial, in particular a coaxially surrounding arrangement of the oscillator coil and the first and second induction coil, respectively. In addition, use of a helical induction coil advantageously provides a substantially homogeneous field configuration in the interior of the coil. In order to prevent deposits on the coils and/or possible corrosion, at least one of, in particular each one of the oscillator coil, the first induction coil and the second induction coil may comprise a protective cover or layer.

In case of a helical coil, at least one of, in particular each one of the oscillator coil, the first induction coil and the second induction coil may have a substantially cylindrical shape. Likewise, the cross-section of at least one of, in particular each one of the oscillator coil, the first induction coil and the second induction coil—as seen along the length axis of the respective coil—may be one of circular, oval, elliptical, rectangular, square, triangular, polygonal.

The aerosol-generating device may further comprise a magnetic flux concentrator for inductively coupling the oscillator coil to at least one of the first induction coil and the second induction coil. Advantageously, the flux concentrator increases the inductive coupling between these coils. As used herein, the term “flux concentrator” refers to an element that is configured to concentrate a magnetic field, that is, to distort a magnetic field so that the density of the magnetic field is increased within a specific volume. Accordingly, the flux concentrator preferably is configured to distort the magnetic field of the oscillator coil towards at least one of the region of the magnetic field of the first induction coil and the region of the second induction coil. In addition, the flux concentrator may be used to reduce the extent to which the magnetic fields propagate beyond the various coils. That is, the flux concentrator preferably acts as a magnetic shield.

Advantageously, this may reduce undesired heating of adjacent susceptive parts of the device, for example a metallic outer housing, or undesired heating of adjacent susceptive items external to the device. By reducing undesired heating losses, the efficiency of the aerosol-generating device may be further improved.

The flux concentrator preferably has a high relative magnetic permeability which acts to concentrate and guide the magnetic field or attic field lines generated by the oscillator coil. As used herein, the term “high relative magnetic permeability” refers to a relative magnetic permeability of at least 100, in particular of at least 1000, preferably of at least 10000, even more preferably of at least 50000, most preferably of at least 80000. These example values refer to the values of relative magnetic permeability at DC and a temperature of 25 degrees Celsius. Likewise, at a frequency of between 6 MHz (Mega-Hertz) and 10 MHz (Mega-Hertz) and a temperature of 25 degrees Celsius, the relative magnetic permeability preferably is 80. As used herein and within the art, the term “relative magnetic permeability” refers to the ratio of the magnetic permeability of a material, or of a medium, such as the flux concentrator, to the magnetic permeability of free space μ_0, where μ_0 is 4π·101-7 N·A-2 (4·Pi·0.10E-07 Newton per square Ampere). Accordingly, the flux concentrator preferably comprises, in particular is made of a material or materials having a relative magnetic permeability of at least of at least 100, in particular of at least 1000, preferably of at least 10000, even more preferably of at least 50000, most preferably of at least 80000. Again, these values refer to the values of relative magnetic permeability at DC and a temperature of 25 degrees Celsius. Likewise, at a frequency of between 6 MHz (Mega-Hertz) and 10 MHz (Mega-Hertz) and a temperature of 25 degrees Celsius the relative magnetic permeability preferably is 80.

Preferably, the flux concentrator comprises a ferromagnetic material, for example a ferrite material such as ferrite particles a ferrite powder held in a matrix, or any other suitable material including a ferrite material such as ferritic iron, ferromagnetic steel or stainless steel. The matrix may comprise a binder, for example a polymer, such as a silicone. The ferromagnetic material may comprise at least one metal selected from iron, nickel, copper, molybdenum, manganese, silicon, and combinations thereof.

For driving the oscillator coil either close to or at the first resonance frequency, or close to or at the second resonance frequency, the driving oscillator circuit preferably comprises a single transistor switch which is selectively operable either close to or at the first resonance frequency, or close to or at the second resonance frequency. Advantageously, usage of a single transistor switch for driving more than one induction coil reduces the complexity of the driving oscillator circuit. In addition, using a single transistor switch is space-saving and, thus, allows for a very compact design of the aerosol-generating device.

The transistor switch may be any type of transistor. For example, the transistor switch may be embodied as a bipolar-junction transistor (BJT). More preferably, however, the transistor switch is embodied as a field effect transistor (FET) such as a metal-oxide-semiconductor field effect transistor (MOSFET) or a metal-semiconductor field effect transistor (MESFET).

The different resonance frequencies of the first LC resonator circuit and the second LC resonator circuit may be realized in several ways. In general, the resonance frequency of a LC circuit comprising an induction coil and a capacitor is given by the formula f=1/(2·π·square root [L·C]), wherein f is the resonance frequency in Hertz, L is the inductance of the induction coil in Henrys, and C is the capacitance of the capacitor in Farads. Accordingly, a specific resonance frequency may be realized by a suitable choice of the capacitance of the capacitor and the inductance of the induction coil. The inductance of the induction coil depends—inter alia—on the number of windings, and, for example in case of a helical coil, on the axial length and the diameter of the coil. Accordingly, a specific inductance of the induction coil may be realized by a suitable choice of the number of windings, the axial length and the diameter of the coil. In general, the inductance increases with in an increasing number of windings. Likewise, the inductance decreases with an increasing length or increasing diameter of the coil. Accordingly, the different resonance frequencies of the first LC resonator circuit and the second LC resonator circuit may be realized by at least one having the an inductance of the first induction coil be different from, in particular larger or smaller than an inductance of the second induction coil, or having a capacitance of the first capacitor be different from, in particular larger or smaller than a capacitance of the second capacitor.

For example, it might be preferable to have the first induction coil and the second induction coil be identical, in particular to have an inductance of the first induction coil be equal to an inductance of the second induction coil. In this case, the different resonance frequencies may be realized by having a capacitance of the first capacitor of the first LC resonator circuit be smaller than a capacitance of the second capacitor of the second LC resonator circuit. Accordingly, an inductance of the first induction coil may be equal to an inductance of the second induction coil, and a capacitance of the first capacitor may be smaller or larger than a capacitance of the second capacitor. In particular, a capacitance of the first capacitor may be 2% (percent), preferably 5% (percent), more preferably 10° A) (percent) smaller or larger than a capacitance of the second capacitor. Of course, is also possible that a capacitance of the second capacitor is smaller or larger, in particular 2% (percent), preferably 5% (percent), more preferably 10% (percent) smaller or larger than a capacitance of the first capacitor.

Alternatively, an inductance of the first induction coil may be smaller or larger, in particular two times, preferably ten times smaller or larger than an inductance of the second induction coil, and a capacitance of the first capacitor may be equal to a capacitance of the second capacitor.

Likewise, it is also possible that an inductance of the first induction coil is different from, in particular larger or smaller than, an inductance of the second induction coil, and that and a capacitance of the first capacitor is different from, in particular larger or smaller than a capacitance of the second capacitor.

In an example, the first induction coil may comprise seven windings and the second induction coil may comprise nine windings, which causes the inductance of the first induction coil be smaller than the inductance of the second induction coil.

At least one of the first induction coil and the second induction coil may have an in inductance in a range between 0.1 μH (micro-Henry) and 2 mH (milli-Henry), in particular between 0.1 μH (micro-Henry) and 1 mH (milli-Henry), preferably between 0.3 μH (micro-Henry) and 1.2 μH (micro-Henry), more preferably between 0.6 μH (micro-Henry) and 0.9 μH (micro-Henry). Depending on the frequency of the magnetic field to be achieved, the values of the capacitance of the first capacitor and the second capacitor may be chosen correspondingly. Preferably, at least one of the first capacitor and the second capacitor has a capacitance in a range between 0.1 nF (nano-Farad) and 20 μF (micro-Farad), in particular between 1 nF (nano-Farad) and 5 μF (micro-Farad), preferably between 10 nF (nano-Farad) an 1 μF (micro-Farad).

As described further above, the alternating magnetic fields of the first induction coil and the second induction coil are used to inductively heat at least one susceptor which in turn is arranged in thermal proximity or direct physical contact with the substrate such as to heat the substrate. In general, the at least susceptor may be either integral part of the device or integral part of an aerosol-generating article which comprises the aerosol-forming substrate to be heated, and is configured to be removably received in the cavity of the aerosol-generating device

As part of the device, the at least one susceptor may be arranged at least partially within the cavity. Likewise, as part of an aerosol-generating article, the at least one susceptor may be arrangeable within the cavity of the aerosol-generating device upon insertion of the article into the cavity of the device.

In particular, the aerosol-generating device may comprise at least one susceptor, in particular one (a single) susceptor or two susceptors.

In case of a single susceptor, the susceptor preferably is arranged within the cavity such that a first portion of the susceptor is arranged at least partially, preferably entirely within the first section of the cavity and a second portion of the susceptor is arranged at least partially, preferably entirely within the second section. Accordingly, in use of the device, the first portion of the susceptor experiences the magnetic field of the first induction coil and the second portion of the susceptor experiences the magnetic field of the second induction coil.

Likewise, in case the aerosol-generating device comprises a plurality of susceptors, in particular two susceptors, the device may comprise a first susceptor and a second susceptor. The first susceptor and the second susceptor are preferably arranged within the cavity such that the first susceptor is arranged at least partially, preferably entirely within the first section of the cavity, and the second susceptor is arranged at least partially, preferably entirely within the second section of the cavity. Accordingly, in use of the device, the first susceptor experiences the magnetic field of the first induction coil and the second susceptor experiences the magnetic field of the second induction coil.

Advantageously, the first section and the second section of the (single) susceptor, or the first susceptor and the second susceptor may be arranged or arrangeable within the aerosol-forming substrate(s) apart from each other such as to heat different portions of an aerosol-forming substrate, in particular a first portion and a second portion of an aerosol-forming substrate, or to heat different aerosol-forming substrates, in particular a first aerosol-forming substrate and a second aerosol-forming substrate.

The first susceptor and the second susceptor may be formed as separate parts. In particular, the first susceptor and the second susceptors may be arranged or arrangeable within the aerosol-forming substrate apart from each.

As used herein, the term “susceptor” refers to an element that is capable to convert electromagnetic energy into heat when subjected to an alternating electromagnetic field. This may be the result of hysteresis losses and/or eddy currents induced in the susceptor, depending on the electrical and magnetic properties of the susceptor material. Hysteresis losses occur in ferromagnetic or ferrimagnetic susceptors due to magnetic domains within the material being switched under the influence of an alternating electromagnetic field. Eddy currents may be induced if the susceptor is electrically conductive. In case of an electrically conductive ferromagnetic or ferrimagnetic susceptor, heat can be generated due to both, eddy currents and hysteresis losses.

Accordingly, the at least one susceptor may be formed from any material that can be inductively heated to a temperature sufficient to generate an aerosol from the aerosol-forming substrate. The at least one susceptor may comprise a metal or carbon. The at least one susceptor may comprise a ferromagnetic material, for example ferritic iron, or a ferromagnetic steel or stainless steel. A preferred susceptor may be formed from 400 series stainless steels, for example grade 410, or grade 420, or grade 430 stainless steel. Another suitable susceptor may comprise aluminum.

The at least one susceptor may comprise a variety of geometrical configurations. The at least one susceptor may comprise or may be a susceptor pin, a susceptor rod, a susceptor blade, a susceptor strip or a susceptor plate. Where the susceptor is part of the aerosol-generating device, the susceptor pin, susceptor pin, the susceptor rod, the susceptor blade, the susceptor strip or the susceptor plate may be project into the cavity of the device, preferably towards an opening of the cavity for inserting an aerosol-generating article into the cavity.

The at least one susceptor may comprise or may be a filament susceptor, a mesh susceptor, a wick susceptor.

Likewise, the at least one susceptor may comprise or may be susceptor sleeve, a susceptor cup, a cylindrical susceptor or a tubular susceptor. Preferably, the inner void of the susceptor sleeve, the susceptor cup, the cylindrical susceptor or the tubular susceptor is configured to removably receive at least a portion of the aerosol-forming substrate to be heated.

The aforementioned susceptors may have any cross-sectional shape, for example, circular, oval, square, rectangular, triangular or any other suitable shape. As used herein, the term “aerosol-generating device” generally refers to an electrically operated device that is capable of interacting with at least one aerosol-forming substrate, in particular with an aerosol-forming substrate provided within an aerosol-generating article, such as to generate an aerosol by heating the substrate. Preferably, the aerosol-generating device is a puffing device for generating an aerosol that is directly inhalable by a user thorough the user's mouth. In particular, the aerosol-generating device is a hand-held aerosol-generating device.

The control circuit according to the present invention may form part of or may be an overall controller of the aerosol-generating device that is configured to control operation of the device. In particular, the controller may be configured to control operation of the induction heating process, in particular induction heating of the aerosol-forming substrate(s) to a pre-determined operating temperature.

The operating temperature used for heating the aerosol-forming substrate(s) may be at least 180 degree Celsius, in particular at least 300 degree Celsius, preferably at least 350 degree Celsius, more preferably at least 370 degree Celsius, most preferably at least 400 degree Celsius. These temperatures are typical operating temperatures for heating but not combusting the aerosol-forming substrate. For example, the operating temperature may be in a range between 180 degree Celsius and 370 degree Celsius, in particular between 180 degree Celsius and 240 degree Celsius or between 280 degree Celsius and 370 degree Celsius. In general, the operating temperature may depend on at least one of the type of the aerosol-forming substrate to be heated, the configuration of the susceptor and the arrangement of the susceptor relative to the aerosol-forming substrate in use of the system. For example, in case the susceptor is configured and arranged such as to surround the aerosol-forming substrate in use of the system, the operating temperature may be in a range between 180 degree Celsius and 240 degree Celsius. Likewise, in case the susceptor is configured such as to be arranged within the aerosol-forming substrate in use of the system, the operating temperature may be in a range between 280 degree Celsius and 370 degree Celsius.

The controller may comprise a microprocessor, for example a programmable microprocessor, a microcontroller, or an application specific integrated chip (ASIC) or other electronic circuitry capable of providing control.

The controller may be configured to generate and provide an alternating driving signal to the oscillator circuit, in particular to the single transistor switch (more specifically to the gate of the single transistor switch), to operate the oscillator circuit, in particular, the single transistor switch either close to or at the first resonance frequency, or close to or at the second resonance frequency. That is, the controller may be configured to generate and provide an alternating driving signal at different frequencies, in particular at a first frequency close or equal to the first resonance frequency and at a second frequency close or equal to the second resonance frequency. For example, the controller may comprise a clock or a voltage controlled oscillator that is configured to provide the respective alternating driving signals.

The aerosol-generating device may comprise a power supply, in particular a DC power supply configured to provide a DC supply voltage and a DC supply current to controller. In particular, the DC voltage may be applied to the drain input and the source input of the single transistor switch. Preferably, the power supply is a battery such as a lithium iron phosphate battery. As an alternative, the power supply may be another form of charge storage device such as a capacitor. The power supply may require recharging, that is, the power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the inductive heating arrangement.

The aerosol-generating device may comprise a main body which preferably includes at least one of the control circuit, in particular the first induction coil and the second induction coil, the first capacitor and the second capacitor, the driving oscillator circuit, the oscillator coil, the single transistor switch (if present), the flux concentrator (if present), the at least one susceptor (if present), the controller, the power supply and at least a portion of the cavity.

In addition to the main body, the aerosol-generating device may further comprise a mouthpiece, in particular in case the aerosol-generating article to be used with the device does not comprise a mouthpiece. The mouthpiece may be mounted to the main body of the device. The mouthpiece may be configured to close the cavity upon mounting the mouthpiece to the main body. For attaching the mouthpiece to the main body, a proximal end portion of the main body may comprise a magnetic or mechanical mount, for example, a bayonet mount or a snap-fit mount, which engages with a corresponding counterpart at a distal end portion of the mouthpiece. In case the device does not comprise a mouthpiece, an aerosol-generating article to be used with the aerosol-generating device may comprise a mouthpiece, for example a filter segment.

The aerosol-generating device may comprise at least one air outlet, for example, an air outlet in the mouthpiece (if present).

Preferably, the aerosol-generating device comprises an air path extending from the at least one air inlet through the cavity, and possibly further to an air outlet in the mouthpiece, if present. Preferably, the aerosol-generating device comprises at least one air inlet in fluid communication with the cavity. Accordingly, the aerosol-generating system may comprise an air path extending from the at least one air inlet into the cavity, and possibly further through the aerosol-forming substrate within the article and a mouthpiece into a user's mouth.

The first induction coil, the second induction coil, the first capacitor, the second capacitor, the oscillator coil and the flux concentrator (if present) may be part of an induction module that is arranged within the device housing and which forms or is circumferentially arranged, in particular removably arranged around at least a portion of the cavity of the device.

According to the invention there is also provided an aerosol-generating system which comprises an aerosol-generating device according to the invention and as described herein. The system further comprises an aerosol-generating article for use with the device, wherein the article comprises an aerosol-forming substrate to be inductively heated by the device. The aerosol-generating article is received or receivable at least partially in the cavity of the device.

As used herein, the term “aerosol-generating system” refers to the combination of an aerosol-generating article as further described herein with an aerosol-generating device according to the invention and as described herein. In the system, the article and the device cooperate to generate a respirable aerosol.

As used herein, the term “aerosol-generating article” refers to an article comprising at least one aerosol-forming substrate that, when heated, releases volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. For example, the article may be a cartridge including a liquid aerosol-forming substrate to be heated. Alternatively, the article may be a rod-shaped article, in particular a tobacco article, resembling conventional cigarettes.

As used herein, the term “aerosol-forming substrate” denotes a substrate formed from or comprising an aerosol-forming material that is capable of releasing volatile compounds upon heating for generating an aerosol. The aerosol-forming substrate is intended to be heated rather than combusted in order to release the aerosol-forming volatile compounds. The aerosol-forming substrate may be a solid or a liquid aerosol-forming substrate or gel-like aerosol-forming substrate or any combination thereof. For example, the aerosol-forming substrate may comprise solid and liquid components, or liquid and gel-like components, or solid and gel-like components, or liquid, solid and gel-like components. The aerosol-forming substrate may comprise a tobacco-containing material containing volatile tobacco flavor compounds, which are released from the substrate upon heating.

Alternatively or additionally, the aerosol-forming substrate may comprise a non-tobacco material. The aerosol-forming substrate may further comprise an aerosol former. Examples of suitable aerosol formers are glycerine, triacetin (glycerin triacetate) and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerine, and which is compressed or molded into a plug.

As mentioned before, the at least one susceptor used for inductively heating the aerosol-forming substrate(s) may be integral part of the aerosol-generating article, instead of being of part of the aerosol-generating device. Accordingly, the aerosol-generating article may comprises at least one susceptor positioned in thermal proximity to or thermal contact with the aerosol-forming substrate such that in use the susceptor is inductively heatable by the inductive heating arrangement when the article is received in the cavity of the device. In particular, the aerosol-forming substrate may comprise one (a single) susceptor or two susceptors.

In case of a single susceptor, the susceptor may be arranged within the article such that upon insertion of the article into the cavity of the device a first portion of the susceptor is arranged at least partially, preferably entirely within the first section of the cavity and a second portion of the susceptor is arranged at least partially, preferably entirely within the second section. Accordingly, in use of the system, the first portion of the susceptor experiences the magnetic field of the first induction coil and the second portion of the susceptor experiences the magnetic field of the second induction coil.

Likewise, in case the aerosol-generating article comprises a plurality of susceptors, in particular two susceptors, the article may comprise a first susceptor and a second susceptor. The first susceptor and the second susceptor may be arranged within the article such that upon insertion of the article into the cavity of the device the first susceptor is arranged at least partially, preferably entirely within the first section of the cavity and the second susceptor is arranged at least partially, preferably entirely within the second section of the cavity. Accordingly, in use of the system, the first susceptor experiences the magnetic field of the first induction coil and the second susceptor experiences the magnetic field of the second induction coil. The first susceptor and the second susceptor may be formed as separate parts.

Advantageously, the first and the second sections of the (single) susceptor, or the first and the second susceptor may be arranged within the aerosol-forming substrate(s) apart from each other such as to heat different portions of an aerosol-forming substrate, in particular a first portion and a second portion of an aerosol-forming substrate, or to heat different aerosol-forming substrates, in particular a first aerosol-forming substrate and a second aerosol-forming substrate, which are arranged at different locations within the article.

Accordingly, the aerosol-generating article may comprise a first aerosol-forming substrate and a second aerosol-forming substrate arranged at different locations within the article. In particular, the first aerosol-forming substrate and the second aerosol-forming substrate may be different from each other, with regard to at least one of content, composition, flavor, texture or state of matter (solid, gel-like, liquid).

Further features and advantages of the aerosol-generating system according to the invention have been described with regard to the aerosol-generating device and will not be repeated.

Of course, it is possible that the aerosol-generating device according to the present invention and as described herein may be configured to separately heat more than two aerosol-forming substrates or more than two portions of an aerosol-forming substrate. Accordingly, the aerosol-generating device according to the present invention and as described herein may comprise more than two induction coils, for example, three, four, five or more induction coils, for generating a respective alternating magnetic field within more than two sections of the cavity, example, in three, four, five or more sections. Accordingly, the aerosol-generating device may comprise more than two LC resonator circuits, one for each coil, wherein each LC resonator circuit includes one of the coils and a respective capacitor, and has a resonance frequency that is different from each one the resonance frequencies of the respective other LC resonator circuits. Likewise, the driving oscillator circuit comprising the oscillator coil may be configured for selectively generating an alternating magnetic oscillator field close to or at more than two frequencies, namely, close to or at the respective resonance frequencies of the different LC resonator circuits. Accordingly, an aerosol-generating article according to the present invention and as described herein may comprise more than two portions of the aerosol-forming substrate, for example, three, four, five or more portions. Likewise, such an article may comprise more than two aerosol-forming substrates, for example, three, four, five or more aerosol-forming substrates. Accordingly, where the susceptor(s) is or are part of the aerosol-generating device, the device may comprise a susceptor having more than two portions, for example, three, four, five or more portions. Likewise, the device may comprise more than two susceptors, for example, three, four, five or more susceptors. Vice versa, where the susceptor(s) is or are part of aerosol-generating article, the article may comprise a susceptor having more than two portions, for example, three, four, five or more portions. Likewise, the article may comprise more than two susceptors, for example, three, four, five or more susceptors.

The invention will be further described, by way of example only, with reference to the accompanying drawings, in which:

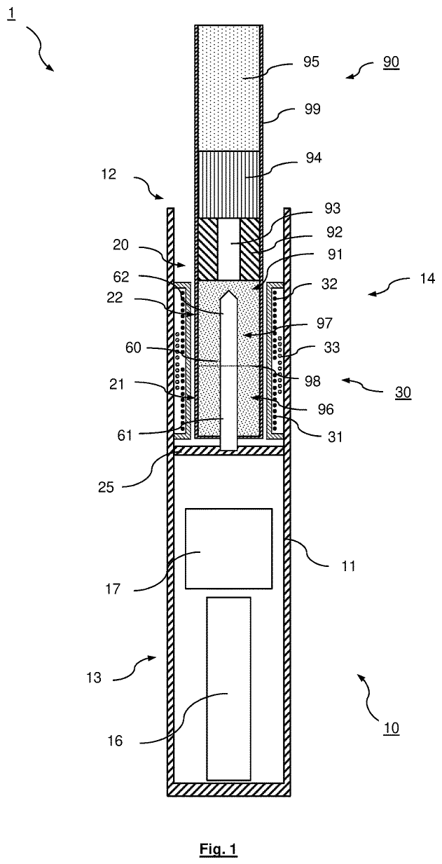

FIG. 1 shows a schematic cross-section of an aerosol-generating system in accordance with a first embodiment of the present invention;

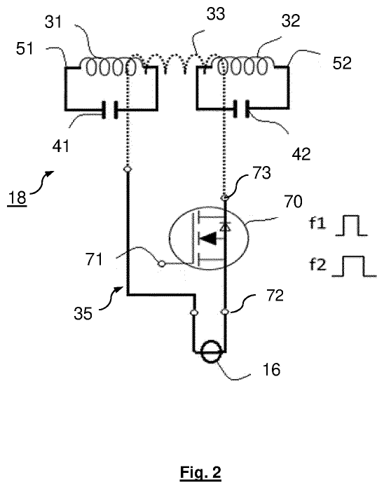

FIG. 2 schematically illustrates an exemplary embodiment of a control circuit that can be used within the aerosol-generating system according to FIG. 1;

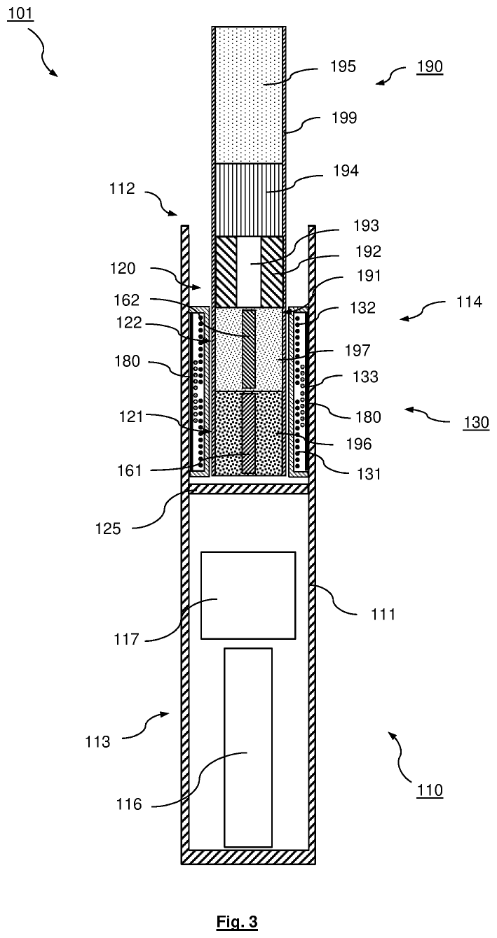

FIG. 3 shows a schematic cross-section of an aerosol-generating system in accordance with a second embodiment of the present invention;

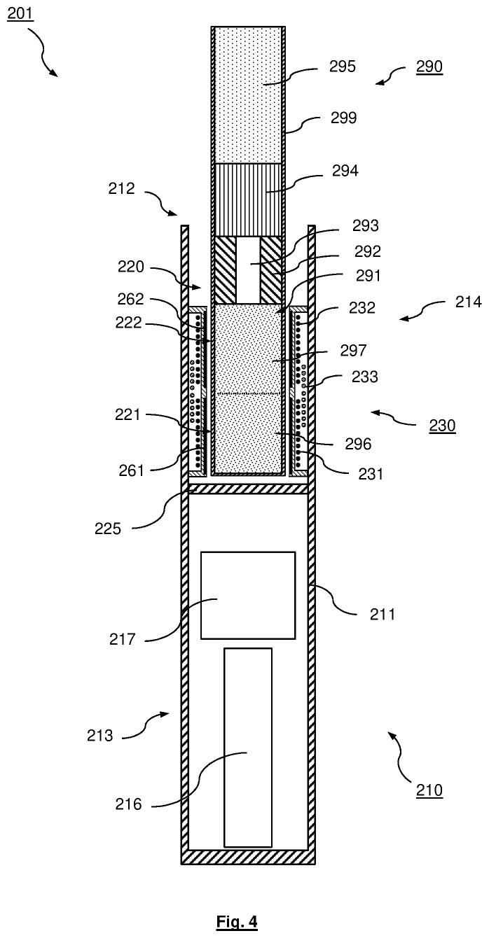

FIG. 4 shows a schematic cross-section of an aerosol-generating system in accordance with a third embodiment of the present invention; and

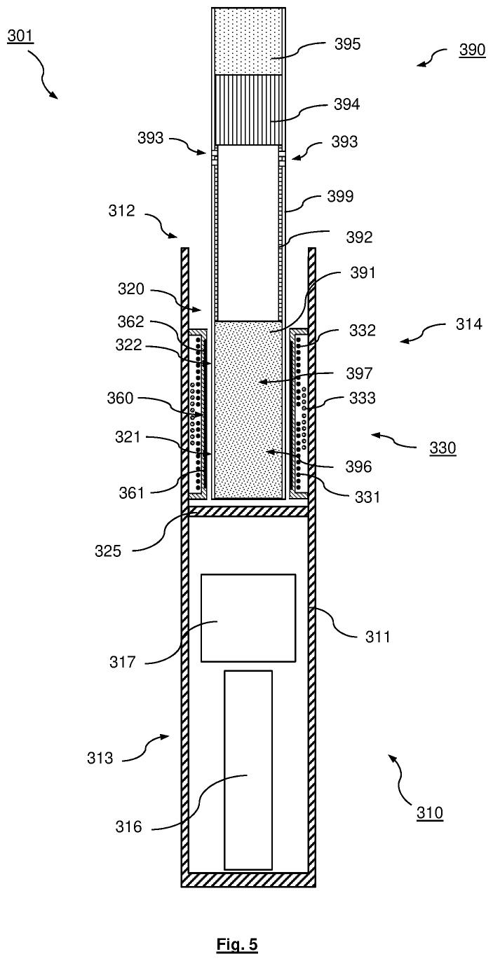

FIG. 5 shows a schematic cross-section of an aerosol-generating system in accordance with a fourth embodiment of the present invention.

FIG. 1 schematically illustrates a first exemplary embodiment of an aerosol-generating system 1 according to the present invention. The system 1 is configured for generating an aerosol by inductively heating an aerosol-forming substrate 91, in particular section-wise or portion-wise. The system 1 comprises two main components: an aerosol-generating article 90 including the aerosol-forming substrate to be heated, and an aerosol-generating device 10 for use with the article 90. The device 10 comprises a cavity 20 for receiving the article 90, and an inductive heating arrangement 30 for heating the substrate within the article 90 when the article 90 is inserted into the cavity 20.

The article 90 has a rod shape substantially resembling the shape of a conventional cigarette. In the present embodiment, the article 90 comprises four elements arranged in coaxial alignment: a substrate segment 91, a support segment 92, an aerosol-cooling segment 94, and a filter segment 95. The substrate segment is arranged at a distal end of the article 90 and comprises the aerosol-forming substrate 91 to be heated. The aerosol-forming substrate may include, for example, a crimped sheet of homogenized tobacco material including glycerine as an aerosol-former. The support segment 92 comprises a hollow core forming a central air passage 93. The aerosol-cooling segment 94 is used for cooling volatilized components of the aerosol-forming substrate. The filter segment 95 serves as a mouthpiece and may include, for example, cellulose acetate fibers. All four elements are substantially cylindrical elements being arranged sequentially one after the other. The segments have substantially the same diameter and are circumscribed by an outer wrapper 99 made of cigarette paper such as to form a cylindrical rod.

The device 10 comprises a substantially rod-shaped main body 11 formed by a substantially cylindrical device housing. Within a distal portion 13, the device 10 comprises a power supply 16, for example a lithium ion battery, and a control circuitry 17 for controlling operation of the device 10, in particular for controlling the inductive heating process.

Within a proximal portion 14 opposite to the distal portion 13, the device 10 comprises the cavity 20. The cavity 20 is open at the proximal end 12 of device 10, thus allowing the article 90 to be readily inserted into the cavity 20. A bottom portion 25 of the cavity 20 separates the distal portion 13 of the device 10 from the proximal portion 14 of the device 10, in particular from the cavity 20. Preferably, the bottom portion 25 is made of a thermally insulating material, for example, PEEK (polyether ether ketone). Thus, electric components of the control circuitry 17 within the distal portion 13 may be kept separate from heat, aerosol or residues produced by the within the cavity 20 during heating of the substrate 91.

The aerosol-generating device 10 according to the present embodiment is configured to heat the aerosol-forming substrate within the substrate segment 91 sections-wise, that is, to separately heat different portions of the aerosol-forming substrate. In the present embodiment, the device 10 is configured to separately heat a first portion 96 and a section 97 of the aerosol-forming substrate. The imaginary separation of the aerosol-forming substrate into the first and section portion 96, 97 is indicated by the dotted line 98 in FIG. 1.

In order to heat the first and section portion 96, 97 separately, the inductive heating arrangement 30 comprises a first induction coil 31 and a second induction coil 32. The first induction coil 31 is arranged and configured to generate an alternating magnetic field within a first section 21 of the cavity 20, whereas the second induction coil 32 is arranged and configured to generate an alternating magnetic field within a second section of the cavity 22. The first and second sections 21, 22 of the cavity 20 are assigned to the locations of the first and section portion 96, 97 of the aerosol-forming substrate when the aerosol-generating article 90 is received in the cavity 20.

The inductive heating arrangement 30 further comprises a susceptor 60 that is arranged within the cavity 20 such that a first portion 61 of the susceptor 60 experiences the electromagnetic field generated by the first induction coil 31 and that a second portion 62 of the susceptor 60 experiences the electromagnetic field generated by the second induction coil 32.

In the present embodiment, the susceptor 60 is a susceptor blade which is attached to the bottom portion 25 of the cavity 20 with its distal end. From there, the susceptor blade extends into the inner void of the cavity 20 towards the opening of the cavity 20 at the proximal end 12 of the device 10. The other end of the susceptor blade 60, that is, the distal free end is tapered such as to allow the susceptor blade to readily penetrate the aerosol-forming substrate within the distal end portion of the article 90. As can be seen in FIG. 1, when the aerosol-generating article 90 is received in the cavity 20, the first portion 61 of the susceptor 60 is arranged within the first portion 96 of the aerosol-forming substrate, whereas the second portion 62 of the susceptor 60 is arranged within the second portion 97 of the substrate. Instead of a blade, the susceptor may also be a susceptor pin or a susceptor rod.

Hence, when activating the first induction coil 31, an alternating electromagnetic field is generated substantially only within the first section 21 of the cavity 20. As a consequence, heating generating eddy currents and/or hysteresis losses are induced substantially only in the first portion 61 of the susceptor 60, depending on the magnetic and electric properties of the susceptor material. Thus, it is substantially only the first portion 61 of the susceptor 60 which is heated, while the second portion 62 of the susceptor 60 remains substantially unheated, when the second induction 32 coil is inactive. Accordingly, only the first portion 96 of the substrate is heated such as to form an aerosol which can be drawn downstream through the aerosol-generating article 90 for inhalation by the user. Likewise, when activating the second induction coil 32 an alternating electromagnetic field is generated substantially only within the second section 22 of the cavity 20 causing only the second portion 62 of the susceptor 60 to be inductively heated, while the first portion 61 of the susceptor 60 remains substantially unheated. As a consequence, only the second portion 97 of the substrate is heated such as to form an aerosol which can be drawn downstream through the aerosol-generating article 90 for inhalation by the user.

In order to allow the first induction coil 31 and the second induction coil 32 being activated independently from each other and, thus, to selectively generate an alternating magnetic field either within the first section 21 or the second section 22 of the cavity 20, each coil 31, 32 is made part of a LC resonator circuit which has a distinct resonance frequency. Each LC resonator circuit is inductively coupled to a (common) driving oscillator coil 32 which can be selectively operated close to or at the distinct resonance frequencies. That is, the present invention is based on inductively driving the first and second induction coil 31, 32, however, each coil at a different driving frequency such as to inductively decouple the operation of the first and second induction coil 31, 32 from each other.

FIG. 2 schematically illustrates an exemplary embodiment of a control circuit 18 that may be used within the aerosol-generating system according to FIG. 1. According to the basic idea described above, the control circuit 18 comprises a first LC resonator circuit 51 and a second LC resonator circuit 52, wherein the first LC resonator circuit 51 includes the first induction coil 31 and a first capacitor 41, and wherein the second LC resonator circuit 52 includes the second induction coil 32 and a second capacitor 42: The first LC resonator circuit 51 has a first resonance frequency, whereas the second LC resonator circuit 52 has a second resonance frequency f2 that is different from the first resonance frequency f1. The control circuit 18 further comprises a driving oscillator circuit 35 comprising an oscillator coil 33 (also shown in FIG. 1) for selectively generating an alternating magnetic oscillator field either close to or at the first resonance frequency f1 or close to or at the second resonance frequency f2. The oscillator coil 33 is inductively coupled to both, to the first induction coil 31 and to the second induction coil 32. However, due to the difference between the first resonance frequency f1 and the second resonance frequency f2, the alternating magnetic oscillator field generated by the oscillator coil 33 substantially only couples into the first induction coil 31 or the first LC resonator circuit 51, respectively, when the frequency of the magnetic oscillator field is close to or equal to the first resonance frequency f1 of the first LC resonator circuit 51. Vice versa, the alternating magnetic oscillator field generated by the oscillator coil 33 substantially only couples into the second induction coil 32 or the second LC resonator circuit 52, respectively, when the frequency of the magnetic oscillator field is close to or equal to the second resonance frequency f2 of the second LC resonator circuit 52.

Accordingly, with reference to FIG. 1, an alternating magnetic field is generated within the first section 21 of the cavity 20, when the oscillator field is close to or at the first resonance frequency f1 and thus close to or on resonance with the first LC resonator circuit 51. Likewise, an alternating magnetic field is generated within the second section 22 of the cavity 21, when the oscillator field is close to or at the second resonance frequency f2 and thus close to or on resonance with the second LC resonator circuit.

Advantageously, the difference between the first resonance frequency f1 and the second resonance frequency f2 also prevents the respective inactive coil from carrying a current induced by the active coil as the inactive coil is sufficiently off-resonant with respect to the current operating frequency of the oscillator coil 33.

Preferably, the difference between the first resonance frequency f1 and the second resonance frequency f2 is at least 40 kHz (kilo-Hertz), in particular at least 100 kHz (kilo-Hertz), preferably at least 100 kHz (kilo-Hertz), more preferably at least 500 kHz (kilo-Hertz) or at least 1 MHz (Mega-Hertz). For example, the first resonance frequency differs from the second resonance frequency by 120 kHz (kilo-Hertz). The first resonance frequency and the second resonance frequency are preferably chosen to be in a range between 100 kHz (kilo-Hertz) to 30 MHz (Mega-Hertz), in particular between 5 MHz (Mega-Hertz) and 15 MHz (Mega-Hertz), preferably between 5 MHz (Mega-Hertz) and 10 MHz (Mega-Hertz). For example, the first resonance frequency may be 150 kHz (kilo-Hertz) and the second resonance frequency may be 270 kHz (kilo-Hertz).

The first induction coil 31 and second induction coil 32 may have, for example, an inductance in a range between 0.3 μH (micro-Henry) and 1.2 μH (micro-Henry), preferably between 0.6 μH (micro-Henry) and 0.9 μH (micro-Henry). Depending on the frequency of the magnetic field to be achieved, the values of the capacitance of the first capacitor 41 and the second capacitor 42 may be chosen correspondingly. Preferably, the first capacitor 41 and the second capacitor 42 have a capacitance in a range between 1 nF (nano-Farad) and 10 μF (micro-Farad), in particular between 10 nF (nano-Farad) and 2 μF (micro-Farad).

For driving the oscillator coil 33 either close to or at the first resonance f1 frequency, or close to or at the second resonance frequency f2, the driving oscillator circuit 35 according to the embodiment shown in FIG. 2 comprises a single transistor switch 70 which is selectively operable either close to or at the first resonance frequency f1, or close to or at the second resonance frequency f2. In the present embodiment, the switch 70 is a field effect transistor (FET) which has a gate input 71 to control the gate terminal. A source input 72 and a drain output 73 of the field effect transistor are in series connection with the oscillator coil 33 and a power source 16, which may correspond to the power source 16 shown in FIG. 1. Accordingly, by applying an alternating driving signal to the gate input 71—having a driving frequency close to or at the first or second resonance frequency f1, f2—the oscillator coil 33 is alternatingly switched on and off at that driving frequency. This switching on and off causes the oscillator coil 32 to generate a magnetic oscillator field close to or at the first or the second resonance frequency f1, f2 due to the changing magnetic flux inside the oscillator coil 33. The alternating driving signal is schematically illustrated in FIG. 2 by two square-wave signal with frequencies f1 and f2. Preferably, the alternating driving signal is generated and provide to the oscillator circuit 35 by means of the control 17 shown in FIG. 1.

As can be seen in FIG. 1, the first and the second induction coils 31, 32 are helical coils circumferentially surrounding the first and second section 21, 22 of the cylindrical cavity 20, respectively. The first and the second induction coils 31, 32 are each formed from a plurality of wire windings extending along the length axis of the respective coil 31. The wire may have any suitable cross-sectional shape, such as square, oval, or triangular. In this embodiment, the wire has a circular cross-section. In other embodiments, the wire may have a flat cross-sectional shape. The same basically holds for the oscillator coil 33.

As can be further seen in FIG. 1, the oscillator coil 33 is arranged coaxially with and partially around each one of the first induction coil 31 and the second induction coil 32. Advantageously, this increases the overlap between the magnetic fields of the different coils and thus increases the inductive coupling between the oscillator coil and the first and the second induction coil, respectively.

FIG. 3 shows a schematic cross-section of an aerosol-generating system 101 in accordance with a second embodiment of the present invention. The system 101 according to FIG. 3 is very similar to the system 1 according to FIG. 1. Therefore, identical or similar features are denoted with same reference numbers, yet incremented by 100. In contrast to the aerosol-generating system 1 according to the first embodiment, the system 101 according to the second embodiment comprises an aerosol-generating article 190 which includes a first aerosol-forming substrate 196 and a second aerosol-forming substrate 197 arranged sequentially one after the other at a distal end portion of the article 190. The first and the second aerosol-forming substrates 196, 197 differ from each other with regard to their compositions and ingredients for enriching the user's experience. Further in contrast to the system 1 according to FIG. 1, the system 101 according to FIG. 3 comprises two susceptors which are not part of the aerosol-generating device 110, but rather part of the aerosol-generating article 190. A strip-like first susceptor 161 is arranged within the first aerosol-forming substrate 196. In a similar way, a strip-like second susceptor 162 is arranged within the second aerosol-forming substrate 197. Both susceptors 161, 162 are arranged centrally within the respective aerosol-forming substrate extending substantially along the longitudinal center axis of the aerosol-generating article 190. In particular, the susceptors 161, 162 are formed as separate parts being spaced apart from each other, which causes both susceptors 161, 162 being thermally decoupled from each other.

Upon insertion of the article 190 into the cavity 120 of the device 110, the first susceptor 161 and the first aerosol-forming substrate 196 are arranged within the first section 121 of the cavity 120. Likewise, the second susceptor 162 and the second aerosol-forming substrate 197 are arranged within the second section 122 of the cavity 120. Hence, in use of the system 101, the first susceptor 161 experiences the magnetic field of the first induction coil 131, whereas the second susceptor 162 experiences the magnetic field of the second induction coil 132 allowing the first and the second aerosol-forming substrates 196, 197 being heated separately from each other.

The aerosol-generating device 110 according to the second embodiment further differs from the device 10 according to the first embodiment by a flux concentrator 180 that is coaxially arranged around the first induction coil 131, the second induction coil 132 and the oscillator coil 133. In the present embodiment, the flux concentrator 180 is a cylindrical element made of a material having a high relative magnetic permeability, for example, a ferromagnetic stainless steel. The flux concentrator 180 is arranged and configured to distort the magnetic field of the oscillator coil 133 towards the region of the magnetic field of the first induction coil 131 and the second induction coil 132, thereby increasing the magnetic coupling between the oscillator coil 133 and the first and second induction coil 131, 132. In addition, as described further above, the flux concentrator acts as a magnetic shield.

Apart from that, the aerosol-generating device at FIG. 3 is identical to the device according to FIG. 1.

FIG. 4 shows a schematic cross-section of an aerosol-generating system 201 in accordance with a third embodiment of the present invention. The system 201 according to FIG. 4 is very similar to the system 101 according to FIG. 3. Therefore, identical or similar features are denoted with same reference numbers, yet incremented by 100. In contrast to the aerosol-generating system 101 according to the second embodiment, the system 201 according to the third embodiment comprises a first susceptor 261 and a second susceptor 262 which are part of the aerosol-generating device 210, but not part of the article 290. In the present embodiment, the first and the second susceptor 261, 262 are susceptor sleeves.

The sleeve-like first susceptor 261 is arranged at the inner surface of the cavity 220, within the outer circumferential periphery of the first section 221 of the cavity 220. There, in use of the device 210, the first susceptor 261 experiences substantially only the magnetic field of the first induction coil 231 Likewise, the sleeve-like second susceptor 262 is arranged at the inner surface of the cavity 220, within the outer circumferential periphery of the second section 222 of the cavity 220. There, in use of the device 210, the second susceptor 262 experiences substantially only the magnetic field of the second induction coil 232. In particular, the first and the second susceptors 261, 262 are formed as separate parts being spaced apart from each other, which causes both susceptors 261, 262 being thermally decoupled from each other.

As described above with regard to FIG. 3, a first and a second aerosol-forming substrate 296, 297 are arranged within the article 290 such that upon insertion of the article 290 into the cavity 220 of the device 210, the first aerosol-forming substrate 296 is arranged within the first section 221 of the cavity 220 and the second aerosol-forming substrate 297 is arranged within the second section 222 of the cavity 220. Thus, the first and the second aerosol-forming substrates 296, 297 may be heated separately from each other.

FIG. 5 shows a schematic cross-section of an aerosol-generating system 301 in accordance with a fourth embodiment of the present invention. The system 301 according to FIG. 5 is very similar to the system 201 according to FIG. 4. Therefore, identical or similar features are denoted with same reference numbers, yet incremented by 100. In contrast to the third embodiment, the aerosol-generating device 310 according to the fourth embodiment comprises a single sleeve-like susceptor 360. The single sleeve-like susceptor 360 is arranged at the inner surface of the cavity 320 relative to a first and a second induction coil 331, 332 such that in use a first portion 361 of the susceptor 360 experiences the electromagnetic field generated by the first induction coil 331 and a second portion 362 of the susceptor 360 experiences the electromagnetic field generated by the second induction coil 332. Thus, the heating arrangement 330 of the device 310 may be used to heat different portions of an aerosol-forming substrate 391 separately. That is, when inserting an article 390 into the cavity 320 and activating the first induction coil 331, the first portion 361 of the susceptor 360 heats a first portion 396 of the aerosol-forming substrate. Likewise, when activating the second induction coil 332, the second portion 362 of the susceptor 360 heats a second portion 397 of the aerosol-forming substrate 391.

Further in contrast to the embodiment shown in FIGS. 1, 3 and 4, the aerosol-generating article 390 according to FIG. 5 does not comprise a support segment. Instead, the article according to FIG. 5 comprises a substrate segment 391 including the aerosol-forming substrate to be heated, an aerosol-cooling segment 392 adjacent to the substrate segment 391 for cooling volatilized components of the aerosol-forming substrate, a filter segment 394 adjacent to the aerosol-cooling segment 392 for filtering volatilized components of the aerosol-forming substrate as well as a mouth end segment 395 adjacent to the filter segment 394 for being received in a mouth of a user. In addition, the article 390 may comprise an end member (not shown) at its distal end opposite to the proximal end, that is, opposite of the mouth end segment 395.

For example, the substrate segment 391 may include an aerosol-forming substrate which comprises strands of homogenized tobacco and an aerosol former, such as glycerol (glycerine), propylene glycol, triacetin (glycerin triacetate) or combinations thereof.

The cooling segment 392 may comprise a hollow tube which defines an air channel for volatilized components of the heated aerosol-forming substrate to flow through and cool down. A thickness of the tube wall may be, for example, 0.29 millimeters. The length of the cooling segment 392 is preferably such that the cooling segment 392 will be partially inserted into the cavity 320, when the article 390 is fully inserted into the device 310. The length of the cooling segment 392 may be between 20 millimeters and 30 millimeters, in particular 23 millimeters and 27 millimeters, preferably 25 millimeters to 27 millimeters, for example, 25 millimeters. The cooling segment 392 may be made of paper, for example, a spirally wound paper tube.

The filter segment 394 may be formed of any filter material sufficient to remove one or more compounds volatilized from the aerosol-forming substrate. For example, the filter segment 394 may be made of a mono-acetate material, such as cellulose acetate. One or more flavors may be added to the filter segment 394 in the form of either direct injection of flavored liquids into the filter segment 394 or by embedding or arranging one or more flavored breakable capsules or other flavor carriers within, for example, the cellulose acetate tow of the filter segment 394. The filter segment 394 may have a length between 6 millimeters and 10 millimeters, for example 8 millimeters.

The mouth end segment 395 serves to prevent any liquid condensate that accumulates at the exit of the filter segment 394 from coming into direct contact with a user. Like the cooling segment 392, mouth end segment 395 may comprise a hollow, in particular annular tube which defines an air channel for volatilized components of the heated aerosol-forming substrate to flow therethrough. The length of the mouth end segment 395 may be between 6 millimeters and 10 millimeters, for example, 8 millimeters. The mouth end segment 395 may be made of paper, for example, a spirally wound paper tube. A thickness of the tube wall may be, for example, 0.29 millimeters.

In addition, the aerosol-generating article 390 according to FIG. 5 comprises a ventilation region to enable air to flow into the interior of the article 390 from the exterior of the article 390. For example, the ventilation region may take the form of one or more ventilation holes formed through the outer layer of the article 390. In particular, the ventilation region may comprise one or more rows of ventilation holes, wherein each row of holes is arranged circumferentially around the article 390 in a cross-section that is substantially perpendicular to a longitudinal axis of the article 390. Each row of ventilation holes may have between 12 to 36 ventilation holes. The ventilation holes may be between 100 to 500 micrometers in diameter. An axial separation between rows of ventilation holes may be between 0.25 millimeters and 0.75 millimeters, for example, 0.5 millimeters. In the present embodiment, the ventilation region comprises two rows of ventilation holes 393, each row being arranged circumferentially around the article 390. As can be seen in FIG. 5, the ventilation holes 393 are located in the cooling segment 392 to aid with the aerosol cooling. In particular, the ventilation holes 393 are arranged such that the ventilation holes 393 are located outside of the cavity 320 when the article 390 is received in the cavity 320, thus allowing non-heated air to enter the article 390 through the ventilation holes 393 from outside. For example, the ventilation holes 393 may be located at least 11 millimeters, in particular between 17 millimeters and 20 millimeters from the proximal end of the article 390. In any case, the location of the ventilation holes is preferably chosen such that a user does not block the ventilation holes 393 during use.

Of course, a ventilation region as describe above, in particular one or more ventilation holes as described above, may also be provided in the aerosol-generating articles 90, 190 and 290 shown in FIGS. 1, 3 and 4.

Together, the cooling segment 392, the filter segment 394 and the mouth end segment 395 may for a filter assembly. For example, the total length of the filter assembly may be between 37 millimeters and 45 millimeters. Preferably, the total length of the filter assembly is about 41 millimeters. The length of the substrate segment 391 may be between 34 millimeters and 50 millimeters, preferably between 38 millimeters and 46 millimeters, for example, 42 millimeters. The total length of the article 390 may be between 71 millimeters and 95 millimeters, preferably between 79 millimeters and 87 millimeters, for example, about 83 millimeters.

Like in the other embodiments shown in FIGS. 1, 3 and 4, all segments 391, 392, 394 and 395 of the article 390 according to FIG. 5 have substantially the same diameter and are circumscribed by an outer wrapper 399 made of cigarette paper such as to form a cylindrical rod.

1.-15. (canceled)

16. An aerosol-generating device for generating an aerosol by inductive heating of an aerosol-forming substrate, the aerosol-generating device comprising:
a device housing comprising a cavity configured to removably receive the aerosol-forming substrate;
at least a first induction coil and a second induction coil, wherein the first induction coil is arranged and configured to generate an alternating magnetic field within a first section of the cavity, and wherein the second induction coil is arranged and configured to generate an alternating magnetic field within a second section of the cavity; and
a control circuit configured to selectively drive the first induction coil and the second induction coil to selectively generate an alternating magnetic field within the first and the second sections, respectively, the control circuit comprising:
a first LC resonator circuit including the first induction coil and a first capacitor, and a second LC resonator circuit including the second induction coil and a second capacitor, wherein the first LC resonator circuit has a first resonance frequency and the second LC resonator circuit has a second resonance frequency that is different from the first resonance frequency, and
a driving oscillator circuit comprising a common oscillator coil configured to selectively generate an alternating magnetic oscillator field having a frequency either close to or at the first resonance frequency, or close to or at the second resonance frequency, wherein the common oscillator coil is inductively coupled to the first induction coil and to the second induction coil such that
an alternating magnetic field is generated within the first section when the frequency of the oscillator field is close to or at the first resonance frequency and thus close to or on resonance with the first LC resonator circuit, and
an alternating magnetic field is generated within the second section when the frequency of the oscillator field is close to or at the second resonance frequency and thus close to or on resonance with the second LC resonator circuit.

17. The aerosol-generating device according to claim 16, wherein the first resonance frequency is in a range between 1 percent and 20 percent of the second resonance frequency.

18. The aerosol-generating device according to claim 16, wherein the first resonance frequency differs from the second resonance frequency by at least 40 kHz.

19. The aerosol-generating device according to claim 16, wherein the first resonance frequency differs from the second resonance frequency by at least 500 kHz.

20. The aerosol-generating device according to claim 16, wherein the first resonance frequency differs from the second resonance frequency by at least 1 MHz.

21. The aerosol-generating device according to claim 16, wherein the first resonance frequency and the second resonance frequency are in a range between 100 kHz and 30 MHz, in a range between 5 MHz and 15 MHz, or in a range between 5 MHz and 10 MHz.

22. The aerosol-generating device according to claim 16, wherein the common oscillator coil is arranged coaxially with each one of the first induction coil and the second induction coil.

23. The aerosol-generating device according to claim 16, wherein the common oscillator coil, the first induction coil, and the second induction coil are helical coils.

24. The aerosol-generating device according to claim 16, wherein the common oscillator coil at least partially surrounds each one of the first induction coil and the second induction coil.

25. The aerosol-generating device according to claim 16, wherein the driving oscillator circuit further comprises a single transistor switch selectively operable either at the first resonance frequency or at the second resonance frequency to drive the common oscillator coil either at the first resonance frequency or at the second resonance frequency.

26. The aerosol-generating device according to claim 16, wherein at least one of the first capacitor and the second capacitor has a capacitance in a range between 1 nF and 10 μF.

27. The aerosol-generating device according to claim 16,
wherein an inductance of the first induction coil is equal to an inductance of the second induction coil, and
wherein a capacitance of the first capacitor is smaller or larger than a capacitance of the second capacitor.

28. The aerosol-generating device according to claim 16,
wherein an inductance of the first induction coil is equal to an inductance of the second induction coil, and
wherein a capacitance of the first capacitor is 2 percent smaller or larger than a capacitance of the second capacitor.

29. The aerosol-generating device according to claim 16,
wherein an inductance of the first induction coil is equal to an inductance of the second induction coil, and
wherein a capacitance of the first capacitor is 10 percent smaller or larger than a capacitance of the second capacitor.

30. The aerosol-generating device according to claim 16, wherein at least one of the first LC resonator circuit and the second LC resonator circuit has a quality factor in a range between 2 and 50.

31. The aerosol-generating device according to claim 16, wherein at least one of the first LC resonator circuit and the second LC resonator circuit has a quality factor in a range between 2 and 20.

32. The aerosol-generating device according to claim 16, further comprising a magnetic flux concentrator configured to inductively couple the common oscillator coil to the first induction coil and to the second induction coil.

33. The aerosol-generating device according to claim 16, further comprising at least one susceptor arranged at least partially within the cavity and surrounded by the first induction coil and the second induction coil.

34. An aerosol-generating system, comprising:
an aerosol-generating device according to claim 16; and
an aerosol-generating article received or receivable at least partially in the cavity of the aerosol-generating device,
wherein the aerosol-generating article comprises at least one aerosol-forming substrate to be heated.

35. The aerosol-generating system according to claim 34, wherein the aerosol-generating article further comprises at least one susceptor positioned in thermal proximity to or in thermal contact with the at least one aerosol-forming substrate such that the at least one susceptor is inductively heatable by an induction source when the aerosol-generating article is received in the cavity of the aerosol-generating device.
